(19) United States
(12) Patent Application Publication
(10) Pub. No.: US 2013/0013515 A1
(43) Pub. Date: Jan. 10, 2013

(54) Secure Payment Device with Separable Display

(75) Inventors: Paul Walters, Scottsdale, AZ (US); Scott Spiker, Phoenix, AZ (US)

(73) Assignee: KEY INNOVATIONS LTD., West Drayton (GB)

(21) Appl. No.: 13/176,469

(22) Filed: Jul. 5, 2011

(51) Int. Cl. G06Q 20/00; H04L 9/32; H04N 7/167; G06F 21/00

(52) U.S. Cl. 705/73; 726/26; 726/16

(57) ABSTRACT

A secure terminal, such as one used for point-of-sale debit card transactions, has a secure enclosure containing some or all of the terminal components, and is configured to send sensitive and non-sensitive data to a display located outside of the secure enclosure. The terminal includes a source chip that protects data sent from the terminal to the display. The source chip protects the data by detecting that the display is connected, authenticating the display as a device that is authorized to receive the data, and encrypting the data before transmission. Preferably, the display is a commercially-available consumer electronic device, such as a television or computer monitor. The source chip communicates with a receiver chip on the display to perform the detection, authentication, and encryption methods of the invention.

### FIELD OF INVENTION

This invention relates to devices for processing electronic transactions. This invention relates particularly to a device for securely processing electronic transactions.

### BACKGROUND

In any transaction where sensitive information is electronically exchanged, there is a need to protect the information from unintended exposure or electronic theft. Typically, the device into which the sensitive information is entered contains cryptographic components that encrypt the information before transmitting it. Unfortunately, for devices that interact with a human user to receive the sensitive data, there is a risk that an attacker may tamper with the device in order to trick the user into entering sensitive data at the wrong time. For example, the attacker may intercept the signal sent to the device's display and insert a prompt for the user to enter sensitive data, such as the user's password or personal identification number (“PIN”), at a point in the transaction that the input is not encrypted. The attacker may then obtain the sensitive data.

Certain industries implement strict controls regarding transaction devices in order to combat such vulnerabilities. In the payment card industry, a person's PIN is highly protected because it may be used to identify the cardholder without intervention from the other party to the transaction, usually a merchant or bank. The Payment Card Industry Security Standards Council (“PCI SSC”) promulgates data security standards that govern the physical implementation and data encryption requirements of all PIN entry devices (“PEDs”). A PED is a point-of-sale (“POS”) terminal that receives a user's PIN as authorization for the transaction. According to the PCI SSC, a PED's components must be protected by a tamper-resistant enclosure. If any of the components, such as a keypad, magnetic card stripe reader, or other input device, are modularized from the main enclosure, each such modular component must itself be contained in a tamper-resistant enclosure, and transmissions of sensitive information between such enclosures must be encrypted. In any device, the display which prompts the user to enter his PIN must be coupled to the device's computer processor, and both the display and the processor must be enclosed in the same secure enclosure. The health care industry implements similar measures, such as the Privacy and Security Provisions defined by the Health Insurance Portability and Accountability Act (“HIPAA”) in the United States, to protect personal health information (“PHI”).

Requiring the display and processor to be housed in a single secure enclosure imposes hardships on the party controlling the POS terminal. The single enclosure is inflexible: components cannot be rearranged and a space large enough for the enclosure must be cleared. Another drawback is that component repair or replacement is inhibited, requiring either a service call or complete removal of the terminal to send it for repairs. Downtime for repairs may therefore be significant. Further, implementation may be confusing to the user. Current self-checkout kiosks, such as at a supermarket, illustrate this drawback: a full-color touch-sensitive display instructs the user how to scan the barcodes on his items, but the user must swipe his card and enter his PIN on a completely separate device with its own enclosed display. Most of these devices have a small, monochrome, dot matrix display that is much more difficult to use than the large color display. A POS terminal that addresses these drawbacks while still conforming to security requirements as least as stringent as those imposed by the PCI SSC is needed. It would be advantageous to provide modular components that can be installed according to the terminal controller's needs, and further advantageous if the display could be a commercially available display, such as a television, monitor, or touchscreen.

Therefore, it is an object of this invention to provide a modular secure POS terminal. It is a further object that the device conform to the security requirements of the payment card industry. Another object of this invention is to provide a secure POS having customizable components. A further object is to provide a device that can use commercially available displays.

### SUMMARY OF THE INVENTION

The present invention is a secure terminal having a secure enclosure containing a computer processor, and a port configured to connect to a display located outside the secure enclosure, the display being in electronic communication with the processor. The processor and display are configured to encrypt and decrypt information and transmit the encrypted information between each other. The transmissions pass between a source chip located on or otherwise electrically connected to the processor, and a receiver chip located on the display. Preferably, the source chip identifies the receiver chip before transmitting data to the display. The source chip authenticates the display as a display that is authorized to receive and display the information to be transmitted. The source chip is configured to only transmit encrypted data to the receiver chip if it can authenticate the display. Further, the source chip may be configured to detect, before sending data to the display, whether the display has been disconnected during the transaction. If the source chip detects that the display is not connected, was previously disconnected, or is not authorized to receive the data, the source chip notifies the processor to suspend or terminate the transaction.

In the preferred embodiment, the display is a commercially-available, high-definition television or monitor that is configured to receive data encrypted according to the High-Bandwidth Digital Copy Protection (“HDCP”) protocol. The preferred display connects to the processor through a High-Definition Multimedia Interface (“HDMI”) port. The connection may be wired or wireless. The source chip and receiver chip are therefore HDCP-capable. The HDCP authentication and connection detection schemes allow data transmitted to the display to be encrypted per industry standards, as well as to be protected from spoofing, eavesdropping, and man-in-the-middle attacks.

### BRIEF DESCRIPTION OF THE DRAWINGS

FIG. 1 is a schematic of a standard POS terminal of the prior art.

FIG. 2 is a schematic illustrating a spoofing attack to which a prior art POS terminal would be susceptible.

FIG. 3 is a schematic of the preferred embodiment of the present invention.

### DETAILED DESCRIPTION OF THE INVENTION

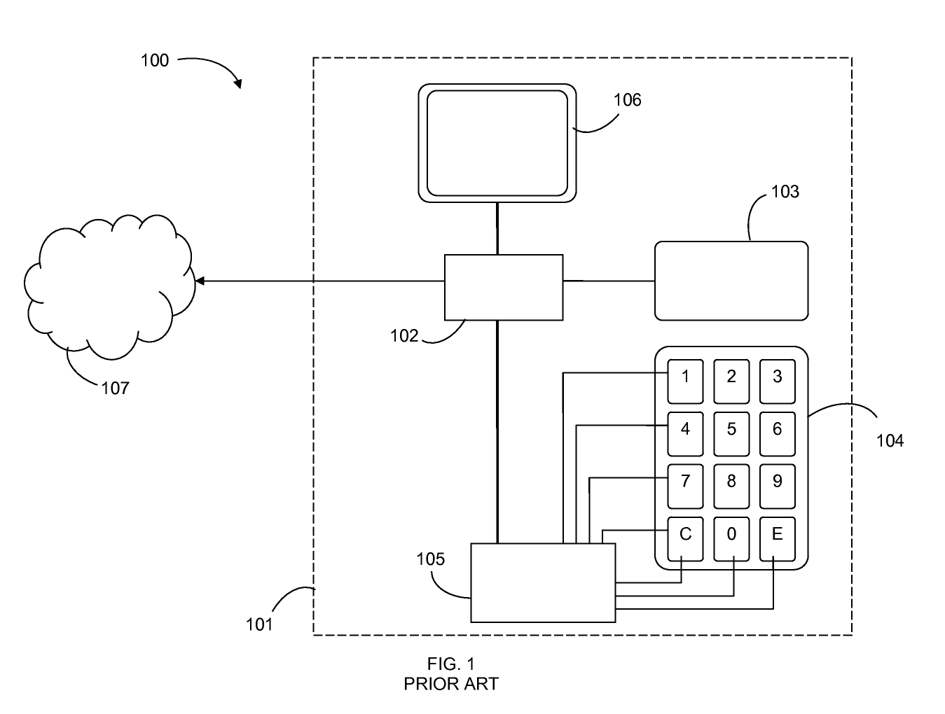

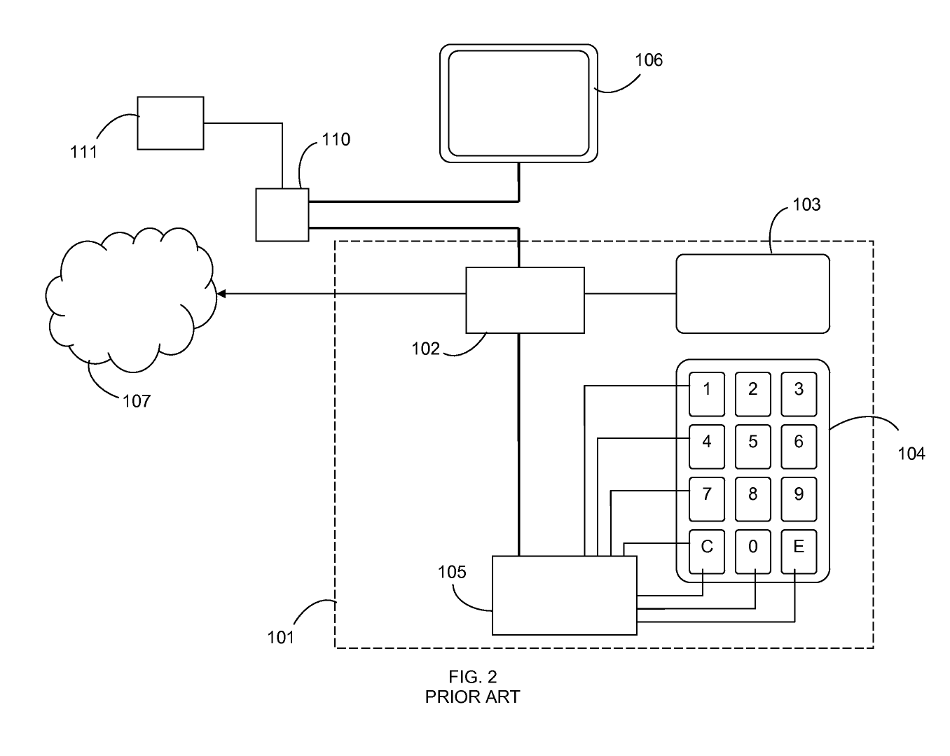

Referring to FIGS. 1 and 2, an illustrated description of the prior art elucidates the present invention. FIG. 1 illustrates a standard, fully-enclosed PED 100, which might serve as a POS terminal at a gas station or a retail store. The PED 100 includes a tamper-resistant enclosure 101 containing the PED 100 components. These components include a central processing unit (“CPU”) 102 that relays data between the other components of the PED 100, and further transmits data over the payment network 107 to a payment processor. One or more input devices, such as a card reader 103 or encrypting PIN pad (“EPP”) 104, are connected to the CPU 102. The input devices receive input from a user and transmit it to the CPU 102 for processing. The input devices may be contained in the enclosure 101, or alternatively may be modular components separately contained in other tamper-resistant enclosures, such modular components transmitting data to the CPU 102 securely as is known in the art. A security processor 105 may receive the data from the input devices and determine whether the data should be encrypted or non-encrypted. The display 106 receives data from the CPU 102 to be presented to the user visually. Typically, this data comprises prompts instructing the user to enter keystrokes or swipe his card. The data sent to the device may further include progress indicators, advertisements, or other visual content. Known displays 106 used on POS terminals are very graphically limited due to the CPU 102 computing power and the use of low-cost parts.

The transmission of data from the CPU 102 to the display 106 is susceptible to interception. Specifically, as described above and illustrated in FIG. 2, a spoofing attack may be executed in which a video switch 110 connected to an unauthorized video source 111 is placed in the signal path between the CPU 102 and the display 106. The video switch 110 receives the data from the CPU 102 and replaces it with unauthorized data from the video source 111. In the worst case, the unauthorized data is a prompt for sensitive information, which the user accepts as genuine and input his PIN or other sensitive information. If the security processor 105 was instructed to receive the input in non-encrypted format, the sensitive information may be transmitted over the payment network 107 without encryption, and may be intercepted there by the attacker. PCI SSC standards therefore require the display 106 to be coupled to the CPU 102 within the enclosure 101 to minimize the spoofing risk.

Device Implementation

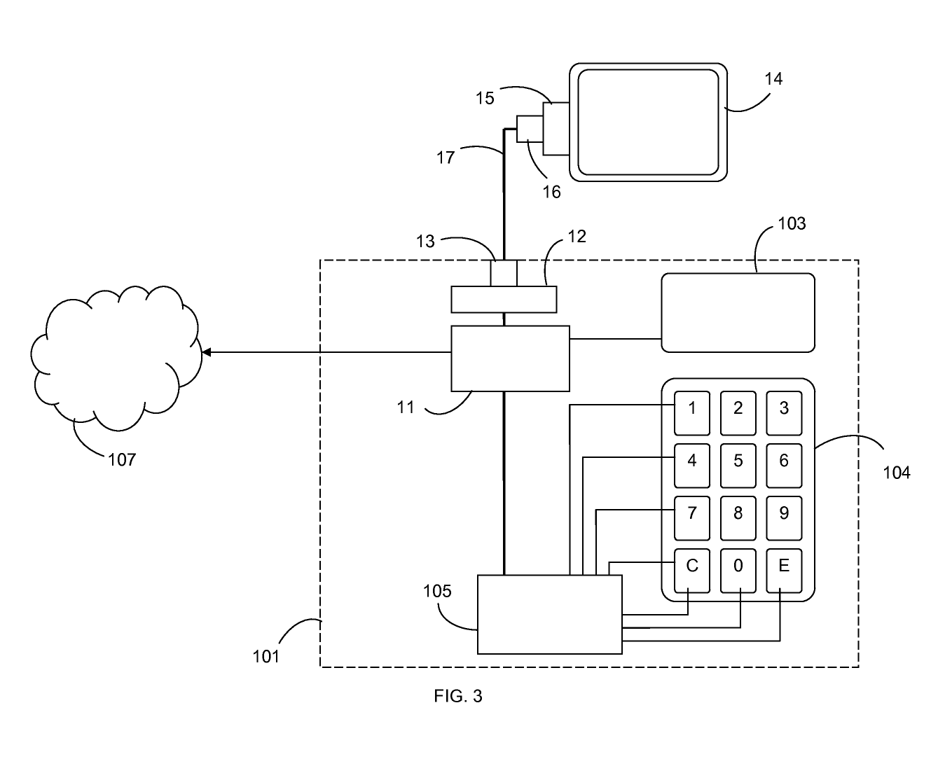

Referring now to FIG. 3, there is illustrated the preferred embodiment of the present invention, designated generally as 10, which is a terminal used to securely process transactions and to display information and prompts to the user on a display 14 that may be decoupled from a application processor 11. Specifically, the display 14 may be located outside of the secure enclosure 101 in which the application processor 11 is housed. In order to prevent an attacker from hijacking, spoofing, eavesdropping upon, or otherwise compromising the security of the transmissions from the application processor 11 to the display 14, the terminal 10 uses authentication techniques to verify that the display 14 is properly connected to the application processor 11 and is authorized to receive transmissions from the application processor 11. Then, the terminal 10 uses encryption techniques to protect data as it is transmitted from the application processor 11 to the display 14. It will be understood that while the authentication and encryption techniques described below may be considered the best mode of practicing the invention, other hardware- or software-based techniques now known or later developed are encompassed by the description.

The application processor 11 may be any processing unit suitable for use in a POS terminal, and further may be capable of processing high-definition video and other multimedia content that present POS terminals are not configured to process. In one embodiment, the application processor 11 may be a system-on-module or system-on-chip (“SOC”) having a microprocessor, memory, and input and output terminals. Examples of a suitable SOC include models TMS320DM355, TMS320DM365, OMAP3, OMAP4, and OMAP5, all by Texas Instruments, Inc. The SOC may be configured to attach to a carrier board, as well as to hardware busses for attaching peripherals. In another embodiment, the application processor 11 may have a CPU in electrical communication with a graphics card. The application processor 11 may communicate with a card reader 103 and an EPP 104, either directly or through a security processor 105, as is known in the art. For example, the security processor 105 may be a USIP® microcontroller attached to the carrier board with the SOC or other application processor 11. The application processor 11 is in electronic communication with the payment network 107 to send and receive data related to a secured transaction that is underway.

A source chip 12 is also contained in the secure enclosure 101 with the application processor 11 and is electrically connected to the application processor 11. The source chip 12 and application processor 11 may be installed on a carrier board or another common printed circuit board (“PCB”) or other conductive substrate, or the source chip 12 may be installed on a separate PCB proximate to the application processor 11. For example, the source chip's 12 PCB may connect to a hardware bus, such as a peripheral component interconnect local bus, that is in communication with the application processor 11. In any embodiment, the electrical connection between the application processor 11 and the source chip 12 is secure, in that it is contained within the tamper-resistant enclosure 101. The source chip 12 may be a digital or other type of integrated circuit configured to authenticate the display 14 and encrypt transmissions to the display as described below. In the preferred embodiment, the source chip 12 is a transmitter capable of implementing one or more data protection schemes used in the consumer electronics industry, such as for transmission of audiovisual data between video players and television sets. Most preferably, the source chip 12 is a HDCP-enabled transmitter such as the ADV7511 transmitter sold by Analog Devices, Inc. The application processor 11 connects to the display 14 through the source chip 12 and a terminal port 13, which is disposed through the enclosure 101 and receives a cable 17 that connects to the display described below. The terminal port 13 may be any port compatible with one or more of the interfaces that the source chip 12 supports. Where the source chip 12 is a HDCP-enabled transmitter, the terminal port 13 may be a HDMI, Digital Visual Interface (“DVI”), Unified Display Interface (“UDI”), Giga-bit Video Interface (“GVIF”), DisplayPort, or wired or wireless TCP/IP port. Most preferably, the terminal port 13 is a HDMI port. The terminal port 13 may be physically attached to or contained in the source chip 12, or the terminal port 13 may be disposed apart from and electrically connected to the source chip 12. Preferably, the terminal port 13 is configured to detect when a connector is attached to or detached from the terminal port 13, and to report the attachment status to the source chip 12.

The display 14, located outside the enclosure 101, may be any display device suitable for conveying information related to POS transactions to the user. Suitable display devices include segment displays, dot matrix displays, and video displays including light-emitting diode displays, electroluminescent displays, plasma display panels, and liquid crystal displays. The display 14 may further be a consumer electronic device such as a television or computer monitor, provided that the display 14 includes a receiver chip 15. The receiver chip 15 may be a digital or other type of integrated circuit configured to identify the display 14 to the application processor 11 or source chip 12 and decrypt transmissions encrypted by the source chip 12 as described below. The receiver chip 15 may further be configured to transmit status information related to the display 14 and the receiver chip 15 to the source chip 12 at predetermined intervals, as described below. In the preferred embodiment, the receiver chip 15 is a receiver capable of implementing one or more data protection schemes used in the consumer electronics industry, such as for transmission of audiovisual data between video players and television sets. Most preferably, the receiver chip 15 is a HDCP-enabled receiver enclosed in a housing of the display 14 as is known in the television industry. The receiver chip 15 connects to the source chip 12 by way of the cable 17, which is attached to the terminal port 13 and a receiver port 16 that extends out of the housing and is either physically attached to or contained in the receiver chip 15, or disposed apart from and electrically connected to the receiver chip 15. The receiver port 16 may be any port compatible with one or more of the interfaces that the receiver chip 15 supports. Where the receiver chip 15 is a HDCP-enabled transmitter, the receiver port 16 may be a HDMI, DVI, UDI, GVIF, DisplayPort, or wired or wireless TCP/IP port. Most preferably, the receiver port 16 is a HDMI port. Preferably, the terminal port 13 is configured to detect when a connector is attached to or detached from the receiver port 16, and to report the attachment status to the source chip 12.

Consumer electronic display devices that contain the preferred receiver chip 15, and therefore may be used as the display 14, are widely available. This lends significant flexibility to terminal 10 installation. Specifically, a vendor may choose a display 14 that is suitable, with respect to size, placement, cost, and display technology, for his particular implementation of the terminal 10. Further, such a display 14 may be bought from a local electronics store and self-installed, rather than relying on the terminal 10 manufacturer to provide a suitable display 14 and employing a skilled technician to install it. HDCP-enabled display devices are configured to display high-definition video, and the terminal 10 may be configured to provide a high-definition video signal to the display 14. As described above, the application processor 11 may handle the video content, which may be stored on a hard drive or other storage device in the enclosure 101. Alternatively, a supplemental processor, such as a graphics card, may process the video content and deliver it to the display 14 through the source chip 12 and receiver chip 15.

In alternate embodiments, the components of the terminal 10 may be partially or fully modularized. For example, the EPP 104 may be located outside of the secure enclosure 101 and may itself be enclosed in a secondary secure enclosure. Communications between such an EPP 104 and the security processor 105 or application processor 11 may be encrypted or otherwise secured as is known in the art. In another embodiment, the secure enclosure 101 may contain only the EPP 104, the application processor 11, and the source chip 12 with the embedded terminal port 13 disposed through the enclosure 101. A reader port (not shown) may also be disposed through the enclosure 101 so the card reader 103 may be attached.

Display Security Measures

In order to protect data to be transmitted from the application processor 11 or other component of the terminal 10 to the remotely-located display 14, the source chip 12 and receiver chip 15 work together to implement one or more, but preferably all, of the following detection, authentication, and encryption methods. A person ordinarily skilled in the implementation of a known data protection protocol, such as HDCP, should be enabled by this description to configure the terminal 10 to communicate with the display 14 using the protocol.

With respect to detection, the source chip 12 detects when a display 14 is connected at the terminal port 13. The detection may comprise a signal, known as a “hot-plug-detect” signal, generated at the terminal port 13 that indicates whether the cable 17 is connected at both the terminal port 13 and the receiver port 16. Once the display's 14 connection is detected, the source chip 12 may then monitor that connection by receiving updates of the connection status. This may be achieved by polling the terminal port 13 at regular intervals, such as every half-second. If the source chip 12 detects that the display 14 has been disconnected, the source chip 12 ceases transmission of data and notifies the application processor 11 of an error. The application processor 11 may then abort any transaction in progress and place the terminal 10 into a “service needed” state, where no transactions may be processed until the display 14 is reconnected and reauthorized. Additionally, once the display 14 has been authenticated as described below, the source chip 12 may receive status information from the receiver chip 15 at regular intervals, such as every second or after a certain number of video frames are transmitted. If the source chip 12 stops receiving the status information from the receiver chip 15, or receives status information indicating a transmission error, the source chip 12 may case transmission of data and notify the application processor 11 as above. Using these detection methods, the application processor 11 will be alerted to any physical tampering with the connection between the terminal 10 and the display 14 and can respond accordingly.

When connection of the display 14 is detected, the source chip 12 attempts to authenticate the display 14. The authentication may include identifying the specific display 14 attached by receiving the display's 14 identifier from the receiver chip 15, if the display 14 has an identifier that may be obtained. The identifier may be stored in the source chip 12 or in a register within the application processor 11 for later retrieval. For example, if the display 14 is detached and then reattached, the source chip 12 may re-obtain the identifier from the receiver chip 15, retrieve the stored identifier, and compare the two identifiers. If the identifiers match, the source chip 12 knows that the display 14 was previously authenticated and can receive data from the application processor 11. The authentication proceeds by verifying whether the display 14 is compatible with the terminal 10. For example, the HDCP-enabled source chip 12 and receiver chip 15 perform the first authentication stage according to the HDCP specification, wherein the source chip 12 uses a combination of unique key selection vectors and HDCP-cipher-generated numbers to determine if the receiver chip 15 is installed in a display device having an active license to use the HDCP protocol. In this example, the source chip 12 may further check the receiver chip's 15 identifier against a stored list of devices having revoked licenses to ensure that the display 14 has not been compromised.

Although the display 14 is authenticated as an authorized receiver of data from the application processor 11, the data may still be susceptible to eavesdropping during transmission. Thus, the source chip 12 may further protect the data by encrypting the data according to a scheme that only the receiver chip 15 can decrypt. In a sample transmission of sensitive data, the application processor 11 generates the data representing a visual prompt for the user to enter his PIN. The data comprises one or more video frames. The application processor 11 delivers the data to the source chip 12, which has already authenticated the connected display 14. The source chip 12 encrypts and transmits the data, frame by frame, across the cable 17 to the receiver chip 15, which decrypts the frames according to the known cipher. The receiver chip 15 then delivers the decrypted frames to the screen of the display 14. Further, as is performed in HDCP connections, the receiver chip 15 may include, in the status information that is sent regularly to the source chip 12, a value related to the synchronization of the encrypted and decrypted data. The source chip 12 may compare this value to its own calculations to determine whether the data remains in sync. If not, the source chip 12 may notify the application processor 11 and cease transmission as described above.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

We claim:

1. A secure terminal comprising:
a) a secure enclosure; and
b) a source chip disposed within the secure enclosure, the source chip being configured to connect to a display outside the secure enclosure and to protect data to be transmitted from the terminal to the display.

2. The secure terminal of claim 1 wherein the display has a receiver chip, and wherein protecting the data to be transmitted from the terminal to the display comprises encrypting the data according to a scheme that the receiver chip is configured to decrypt.

3. The secure terminal of claim 2 wherein protecting the data to be transmitted from the terminal to the display further comprises authenticating the display before transmitting the data to the display.

4. The secure terminal of claim 3 wherein authenticating the display comprises verifying whether the display is compatible with the secure terminal.

5. The secure terminal of claim 4 wherein authenticating the display further comprises receiving an identifier from the receiver chip.

6. The secure terminal of claim 1 further comprising a terminal port disposed through the secure enclosure and in electrical communication with the source chip.

7. The secure terminal of claim 6 wherein protecting the data to be transmitted from the terminal to the display comprises detecting whether the display is electrically connected to the terminal port.

8. The secure terminal of claim 7 wherein detecting whether the display is electrically connected to the terminal port comprises receiving a signal from the terminal port that the display is connected.

9. The secure terminal of claim 7 wherein detecting whether the display is electrically connected to the terminal port comprises receiving status information from the display at regular intervals.

10. The secure terminal of claim 6 wherein the terminal port is a High Definition Multimedia Interface port.

11. The secure terminal of claim 6 wherein the terminal port is a Digital Visual Interface port.

12. The secure terminal of claim 1 wherein the display is a commercially-available consumer electronic device.

13. The secure terminal of claim 12 wherein the display is a television.

14. The secure terminal of claim 12 wherein the display is a computer monitor.

15. A secure terminal comprising:
a) a secure enclosure;
b) a terminal port disposed through the secure enclosure;
c) a source chip disposed within the secure enclosure and in electrical communication with the terminal port, the source chip being configured to connect to a display having a receiver chip and being located outside the secure enclosure, and the source chip being further configured to protect data to be transmitted from the terminal to the display by:
i. detecting that the display is attached to the terminal port;
ii. authenticating the display as being authorized to receive the data; and
iii. encrypting the data according to a scheme that the receiver chip is configured to decrypt;
d) an application processor disposed within the secure enclosure and in electrical communication with the source chip, the application processor being configured to connect to a payment network; and
e) an encrypting personal identification number pad in electrical communication with the application processor.

16. The secure terminal of claim 15 wherein the display is a commercially-available consumer electronic device.

17. The secure terminal of claim 16 wherein the terminal port is a High Definition Multimedia Interface port.

18. The secure terminal of claim 16 wherein the terminal port is a Digital Visual Interface port.

19. The secure terminal of claim 16 wherein the source chip is an HDCP-enabled transmitter.

20. A secure terminal comprising:
a) a secure enclosure;
b) a terminal port disposed through the secure enclosure and configured to receive a cable connected to a display which:
i. is located outside the secure enclosure;
ii. has a HDCP-enabled receiver; and
iii. is a commercially-available consumer electronic device;
c) an HDCP-enabled transmitter disposed within the secure enclosure and in electrical communication with the terminal port, the transmitter being configured to protect data to be transmitted from the terminal to the display by:
i. detecting that the display is attached to the terminal port;
ii. authenticating the display as being authorized to receive the data;
iii. encrypting the data according to HDCP protocol; and
iv. sending the encrypted data to the receiver, which decrypts the data;
d) an application processor disposed within the secure enclosure and in electrical communication with the source chip, the application processor being configured to process high-definition video content and to connect to a payment network; and
e) an encrypting personal identification number pad in electrical communication with the application processor.
